(19) United States
(12) Patent Application Publication
(10) Pub. No.: US 2025/0053618 A1
(43) Pub. Date: Feb. 13, 2025

(54) NODE AND METHODS PERFORMED THEREBY FOR HANDLING DRIFT IN DATA

(71) Applicant: Telefonaktiebolaget LM Ericsson (publ), Stockholm (SE)

(72) Inventors: Sumit SOMAN, Noida, Uttar Pradesh (IN); Arpit SISODIA, Noida, Uttar Pradesh (IN); Ranjani H G, Bangalore, Karnataka (IN); Ankit JAUHARI, Bangalore (IN); Sunil Kumar VUPPALA, Bangalore (IN)

(21) Appl. No.: 18/722,990

(22) PCT Filed: Dec. 24, 2021
(86) PCT No.: PCT/IN2021/051204

§ 371 Date: Jun. 21, 2024

(51) Int. Cl. G06F 18/241; G06F 18/10

(52) U.S. Cl. CPC G06F 18/241; G06F 18/10

(57) ABSTRACT

A method performed by a node for handling drift in data. The node obtains a dataset including a plurality of datapoints corresponding to a plurality of values of one or more dependent variables for a plurality of first features over a time period. The node determines, using machine learning and explainability, in the absence of determining whether or not the plurality of datapoints has a drift, whether or not there has been a change in respective one or more characteristics of a subset of the plurality of first features having a largest contribution to a variability of the datapoints in the plurality of datapoints based on a threshold from a first time period to a second time period. The node then initiates application of a drift policy on the plurality of datapoints based on a result of the determination.

### TECHNICAL FIELD

The present disclosure relates generally to a node and methods performed thereby for handling drift in data. The present disclosure further relates generally to computer programs and computer-readable storage mediums, having stored thereon the computer programs to carry out these methods.

### BACKGROUND

Computer systems in a communications network or system may comprise one or more nodes. A node may comprise one or more processors which, together with computer program code may perform different functions and actions, a memory, a receiving port and a sending port. A node may be, for example, a server. Nodes may perform their functions entirely on the cloud.

The communications network may cover a geographical area which may be divided into cell areas, each cell area being served by another type of node, a network node in the Radio Access Network (RAN), radio network node or Transmission Point (TP), for example, an access node such as a Base Station (BS), e.g., a Radio Base Station (RBS), which sometimes may be referred to as e.g., Fifth Generation (5G) Node B (gNB), evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood as the geographical area where radio coverage is provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

User Equipments (UEs) within the communications network may be e.g., wireless devices, stations (STAs), mobile terminals, wireless terminals, terminals, and/or Mobile Stations (MS). UEs may be understood to be enabled to communicate wirelessly in a cellular communications network or wireless communication network, sometimes also referred to as a cellular radio system, cellular system, or cellular network. The communication may be performed e.g., between two UEs, between a wireless device and a regular telephone and/or between a wireless device and a server via a Radio Access Network (RAN) and possibly one or more core networks, comprised within the wireless communications network. UEs may further be referred to as mobile telephones, cellular telephones, laptops, or tablets with wireless capability, just to mention some further examples. The UEs in the present context may be, for example, portable, pocket-storable, hand-held, computer-comprised, or vehicle-mounted mobile devices, enabled to communicate voice and/or data, via the RAN, with another entity, such as another terminal or a server.

In 3rd Generation Partnership Project (3GPP) Long Term Evolution (LTE), base stations, which may be referred to as gNBs. eNodeBs or even eNBs, may be directly connected to one or more core networks.

Nodes in a core network may use Machine Learning (ML) techniques to analyze data in the communications network.

The performance of ML models may be affected by changes in data distribution, which may be caused due to various factors. This may be typically referred to as drift [1]. Drift may be understood to occur when the distribution of dependent or independent variables changes over time. Degradation of model performance due to drift affects their Life Cycle Management (LCM) operations, as practitioners may be understood to have to re-train or replace existing model(s) to meet performance benchmarks. Another challenge is efficiently detecting occurrence of drift, so that remedial action, involving drift resolution or model re-training activities, may be taken in a timely manner to reduce operational or revenue losses.

An example in this context may include ML models trained to predict Key Performance Indicators (KPIs) on data from Performance Management (PM) counters. In typical Managed Services for Networks (MSN) projects, ML engineers compute various KPIs from PM counter data provided as numeric time-series data, with timestamps to indicate the time at which the sample was acquired. Using the counter data, after suitable pre-processing and computing KPIs, ML model(s) may be trained to predict a target KPI using a set of feature KPIs. The trained model(s) may then be used in an online setting to predict the target KPI from online stream(s) of feature KPIs computed from counter data. Based on the model prediction(s) during configured Reporting Operating Periods (ROPs), the operator may execute suitable actuation(s) to restore the target KPI, which would otherwise have caused a degradation in network performance, affecting end users.

When drift occurs in counter data, for example, when network activity may spike unusually during high usage in post-pandemic scenarios due to a large number of video calls, or employees working from home, it affects the computed KPI(s), and consequently model performance degrades due to high error(s) in prediction(s). This may confound operator actuations that may have adverse implications. In such scenarios, it may be understood to become important to detect drift in a timely and efficient manner, so that mitigation strategies may be employed in the LCM to enable only warranted actuations.

A typical workflow for handling drift in the LCM pipeline, shown in the schematic diagram in FIG. 1, may comprise the following steps. First, drift may be detected using drift detection algorithm(s), such as PageHinkley [2], Hoeffding Drift Detection Method (HDDM) [3] among other(s), on feature(s), target(s) or model error metric(s) independently. Second, sample(s) may be flagged where feature(s) or target(s) may be in individual or collective drift, as determined by the drift detection algorithm(s). Third, to address the effect of samples in drift LCM activities may be executed, including model re-training, replacement, or switching to previous model version(s). Fourth, additionally, the cause of drift may also be examined using suitable explainability based algorithms in a post-hoc setting [4, 5]. Explainability may be understood to entail approach(es) that may be used to determine the important features, or variables, that may have led to an output predicted by an ML model. When there is drift in a target KPI of interest, such as e.g., downlink throughput, conventional approaches may use explainability to determine which KPIs, used as features to train the model, may have caused the target KPI to drift. This analysis may be usually done after a drift detection algorithm has been used to identify drift on the entire dataset based on the Artificial Intelligence (AI)/ML model performance. For example, the number of connected users may be an explaining feature that resulted in downlink throughput drift, and this has been identified by using explainability after, that is, post-hoc, a drift detector may have indicated that the target KPI is in drift.

Some of the existing methods focus on identifying and using threshold(s) for drift detection, such as CN110781781A, using change point sequences such as CN112347416, computing windowed correlation between features and target such as CN106934035B, or using compensation functions such as WO2021044192A1. These methods require efficiently identifying the threshold(s) and may not scale well for long-term drift detection as the thresholds may change over time.

Other existing methods use model performance metrics for drift detection, such as CN103414739B, use separate sidecar models, such as US20190147357A1 and US20200151619A1, or evaluate drift based on difference in model parameters, such as U.S. Ser. No. 10/599,957. These may pose high demands on computational, energy and time resources.

Yet other existing methods use statistical measures on features to detect drift, including methods based on missing time steps or seasonality such as US20210042382A1, methods based on entropy such as CN110445726, methods based on Intrinsic Mode Decomposition (IMD) such as CN110781781A, or methods based on undersampling or oversampling for imbalanced data such as CN112000705A. These methods may be less effective in identifying drift in the target KPI due to drift in the feature KPIs from previous time instant(s).

Existing methods to handle drift in data may lack effectiveness and may pose high demands on computational, energy and time resources in a communications network.

### SUMMARY

As part of the development of embodiments herein, one or more challenges with the existing technology will first be identified and discussed.

As discussed in the previous section, using drift detection algorithm(s) on feature(s), target(s) or model error metric(s) independently may be unable to capture, cases where drift may occur in the target KPI(s) at a given time instant due to changes, that is, drift, in feature KPI(s) at previous time instants. This may apply specifically, when Xₜ₊₁∝ŷₜ,ŷₜ₋₁, . . . ŷₜ₋ᵢ, where Xₜ₊₁ represents the KPIs at time instant (t+1) and ŷₜ represents the target KPI(s) at time instant t. For example, if the target KPI at time ‘t’ is downlink throughput, it may significantly decrease if the number of connected users, a feature KPI, have increased in prior time windows, for e.g., during t−15 mins, t−10 mins and t−5 minutes, e.g., the number of users increased as 10, 100, 1000, respectively, and as an example, not significantly due to a KPI such as cell downtime, in previous time instants. Alternatively, actuations such as traffic load hand overs which may be aimed at optimizing the network by predicting cells where the downlink throughput, if that is the target KPI, may be degraded, and in turn may result in an ability to accommodate more users per cell due to available resources. For example, in the case of drift in downlink throughput, if an actuation such as traffic load handover is executed based on detecting drift in a non-important, that is a non-explaining KPI, it may have undesirable consequences, such as not being able to accommodate more users. Thus, it may be understood to be important to execute these actuations only when the drift is due to determining, that is, explaining, feature KPIs, such as drift in number of connected users, rather than drift in cell downtime.

Moreover, the computational cost of running drift detection algorithms on all KPIs for identifying drift may be understood to be considerable, and may lead to increased latency. Hence, existing drift detection methods are not an optimal LCM policy to adopt.

Furthermore, when handling drift and resulting scenarios in network management use-cases, in order to select and execute a speedy drift resolution policy in LCM workflows, existing methods lack feedback and may need human intervention. For example, if drift detection is run on all KPIs, then manual, that is, human, intervention may be required to select and execute a resolution policy using the affecting KPIs, e.g., re-training, update, or replacement of models, which may involve, for example, using explainability to identify such KPIs post-hoc. This may then provide “feedback” for selection and execution of a drift resolution policy.

According to the foregoing, it is an object of embodiments herein to improve the handling of drift in data in a communications system.

According to a first aspect of embodiments herein, the object is achieved by a computer-implemented method, performed by a node. The method is for handling drift in data. The node operates in a communications system. The node obtains a dataset. The dataset comprises a plurality of datapoints. The plurality of datapoints correspond to a plurality of values of one or more dependent variables for a plurality of first features over a time period. The node then determines, using machine learning and explainability, in the absence of determining whether or not the plurality of datapoints has a drift, whether or not there has been a change. The change is in respective one or more characteristics of a subset of the plurality of first features in the plurality of datapoints. The subset of the plurality of first features have a largest contribution to a variability of the datapoints in the plurality of datapoints, based on a threshold, from a first time period to a second time period. The first node then initiates application of a drift policy on the plurality of datapoints. The first node initiates application of the drift policy based on a result of the determination of whether or not there has been a change.

According to a second aspect of embodiments herein, the object is achieved by the node, for handling drift in data. The first node is configured to operate in the communications system. The first node is further configured to obtain the dataset. The dataset is configured to comprise the plurality of datapoints configured to correspond to the plurality of values of the one or more dependent variables for the plurality of first features over the time period. The first node is also configured to determine, using machine learning and explainability, in the absence of determining whether or not the plurality of datapoints has a drift, whether or not there has been a change. The change is configured to be in the respective one or more characteristics of the subset of the plurality of first features in the plurality of datapoints. The subset of the plurality of first features is configured to have the largest contribution to the variability of the datapoints in the plurality of datapoints based. The largest contribution is based on a threshold. The changes is configured to be from the first time period to the second time period. The first node is additionally configured to initiate application of the drift policy on the plurality of datapoints based on the result of the determination of whether or not there has been a change.

According to a third aspect of embodiments herein, the object is achieved by a computer program, comprising instructions which, when executed on at least one processor, cause the at least one processor to carry out the method performed by the node.

According to a fourth aspect of embodiments herein, the object is achieved by a computer-readable storage medium, having stored thereon the computer program, comprising instructions which, when executed on at least one processor, cause the at least one processor to carry out the method performed by the node.

By the node obtaining the dataset, the node may be enabled to monitor whether there may be any changes in the behavior of the one or more dependent variables, which may require a change to the predictive model. The change to the predictive model may be, e.g., retraining, replacement or reverting to an earlier version of the predictive model. Hence, the node may in turn be enabled to ensure that it may be able to monitor and predict the one or more variables with the highest accuracy, thereby ensuring that performance of the communication system may be dynamically monitored and optimized.

By determining whether or not there has been a change in which first features are comprised in the first subset and in the second subset and in their respective one or more respective characteristics of the subset of the plurality of first features in the plurality of datapoints having the largest contribution to the variability of the datapoints, from the first time period to the second time period, the node may be able to assess whether one or more of the one or more dependent variables at a current time instant may be affected by first feature(s) at other time instants for network management use-cases. By the node performing this assessment using explainability pre-hoc, that is, in the absence of, that is, before, determining whether or not the plurality of datapoints has a drift, the node may be enabled to trigger a drift resolution policy on a specific set of the first feature(s) or sample(s), which specific set may be understood to be a reduced set. If this may be empirically substantiated, the node may then use deviated local interpretability to trigger, for example, retraining of the predictive model, by choosing samples for drift handling, as part of drift handling, or management, policy. The node may be understood to advantageously perform this assessment unlike conventional methods, that may use explainability post-hoc to analyze the cause(s) of drift. As drift detection algorithms may typically use statistical measures to estimate difference in distribution of data in time windows, it may be understood to limit the understanding of practitioners on the cause of the drift, for which explainability may be leveraged post-hoc in conventional settings. However, as embodiments herein may employ drift selection driven by explainability, an understanding of the contributing features may be inferred.

Embodiments herein may be understood to leverage the use of model predictions in the LCM to determine sample(s) potentially in drift. This may be understood to have two advantages. Firstly, the computational cost of running drift detection algorithms on all the datapoints, e.g., all the feature(s), target(s), or model error metric(s) which may be conventionally done to detect drift, may be understood to be reduced. Secondly, drift in the one or more dependent variables, that is, target variable(s), may be correlated to drift in the first feature(s) by implicitly using explainability values, which may be understood to justify the premise of drift detection in network management scenarios. Embodiments herein provide an optimal approach to drift detection, as opposed to running drift detectors over all features, e.g., KPIs, making it practically advantageous to implement drift detection-based LCM in pipelines for managed services for networks.

Unlike existing methods, wherein drift is determined by continuously monitoring the performance index parameters exceeding specific threshold(s), the node may be understood to allow for robust drift detection when the one or more dependent variables, e.g., target KPIs, may be affected, that is, drifted, due to change in the plurality of first features, e.g., feature KPIs, which may be captured by model-based explanations. For example, Physical Resource Block utilization, Downlink Block Error Rate and Physical Downlink Control Channel utilization may be examples of feature KPIs that may be important in determining how a target KPI such as downlink throughput may have degraded, that is, drifted from the first time period to the second time period, and these determining features may be identified by computing explainability of the plurality of first features, e.g., feature KPIs, using the predictive model responsible for predicting the one or more dependent variables, e.g., target KPI, using these subset of the plurality of first features, e.g., features.

By initiating application of the drift policy, the node may then be enabled to mitigate, or manage, the effects of the drift.

### BRIEF DESCRIPTION OF THE DRAWINGS

Examples of embodiments herein are described in more detail with reference to the accompanying drawings, according to the following description.

FIG. 1 is a schematic diagram illustrating a conventional workflow involving drift detection and explainability, according to existing methods.

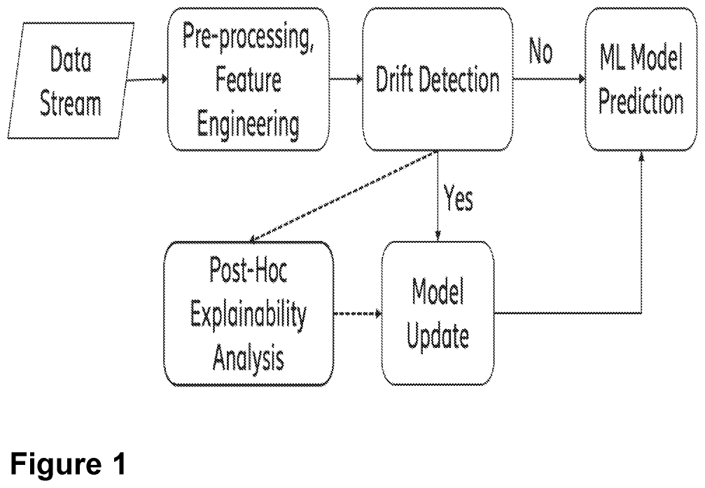

FIG. 2 is a schematic diagram illustrating a non-limiting example of a communications system, according to embodiments herein.

FIG. 3 is a flowchart depicting embodiments of a method in a node, according to embodiments herein.

FIG. 4 is a schematic diagram depicting aspects of the method performed by the node in a non-limiting example, according to embodiments herein.

FIG. 5 is a schematic diagram depicting aspects of the method performed by the node in another non-limiting example, according to embodiments herein.

FIG. 6 is a schematic diagram depicting aspects of the method performed by the node in further non-limiting example, according to embodiments herein.

FIG. 7 is a schematic diagram depicting aspects related to the method performed by the node in a non-limiting example, according to embodiments herein.

FIG. 8 is a schematic diagram depicting aspects related to the method performed by the node in another non-limiting example, according to embodiments herein.

FIG. 9 is a schematic block diagram illustrating two non-limiting examples, a) and b), of a node, according to embodiments herein.

### DETAILED DESCRIPTION

Certain aspects of the present disclosure and their embodiments address the challenges identified in the Background and Summary sections with the existing methods and provide solutions to the challenges discussed.

Although drift detection has been a widely studied research problem, conventional drift detectors are run on feature(s), target(s) or model error metric(s) independently, and hence may not be able to capture drift in scenarios where such co-relations may exist. Embodiments herein may specifically focus on the occurrence of drift in such network management scenarios. Of particular interest may be cases where the drift in feature KPI(s) at a given time instant may be dependent on the drift in target KPI(s) of previous time instants.

The computational cost of evaluating drift detection algorithms may also be understood to be an important factor to consider in efficient LCM practices.

Embodiments herein may be understood to overcome the challenges of the existing methods by providing a method and system for an explainability driven drift policy selection for network management. A drift policy may be understood to refer to one or more methods that may be adopted to mitigate the effects of drift.

As a summarized overview, embodiments herein relate to a method for leveraging explainability to detect a change in explaining features corresponding to a target variable to trigger a drift detection policy on a subset of the identified sample(s) or/and feature(s).

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

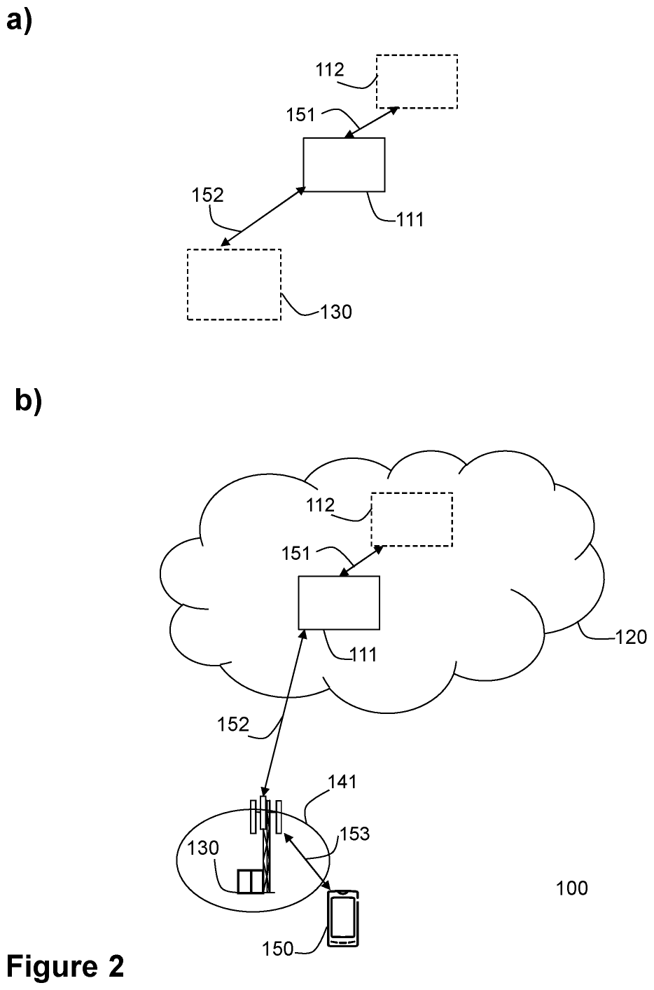

FIG. 2 depicts two non-limiting examples, in panels “a” and “b”, respectively, of a communications system 100, in which embodiments herein may be implemented. In some example implementations, such as that depicted in the non-limiting example of FIG. 2a, the communications system 100 may be a computer network. In other example implementations, such as that depicted in the non-limiting example of FIG. 2b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as a 5G system, e.g., 5G Core Network (CN), 5G New Radio (NR), or a newer system supporting similar functionality. The telecommunications system may also support other technologies, such as, e.g., an Internet of Things (IoT) network, a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 comprises a node 111, which may be also referred to as a first node 111. which is depicted in FIG. 2. In some embodiments, the communications system 100 may comprise a plurality of nodes, whereof, another node 112. which may be also referred to as a second node 112, is depicted in FIG. 2. It may be understood that the communications system 100 may comprise more nodes than those represented in FIG. 2. Any of the node 111 and the another node 112 may be understood, respectively, as a first computer system and a second computer system. In some examples, any of the node 111, and the another node 112 may be implemented as a standalone server in e.g., a host computer in the cloud 120, as depicted in the non-limiting example depicted in panel b) of FIG. 2. Any of the node 111 and the another node 112 may, in some examples, be a distributed node or distributed server, with some of their respective functions being implemented locally, e.g., by a client manager, and some of its functions implemented in the cloud 120, by e.g., a server manager. Yet in other examples, any of the node 111 and the another node 112, may also be implemented as processing resources in a server farm.

In some embodiments, the node 111 and the another node 112 may be independent and separated nodes. In other embodiments, the node 111 and the another node 112 may co-localized or be the same node. All the possible combinations are not depicted in FIG. 2 to simplify the Figure.

The node 111 and the another node 112 may be understood as a node having a capability to perform machine-learning.

In some non-limiting examples, the communications system 100 may comprise one or more radio network nodes, whereof a radio network node 130 is depicted in panel b) of FIG. 2. The radio network node 130 may typically be a base station or Transmission Point (TP), or any other network unit capable to serve a wireless device or a machine type node in the communications system 100. The radio network node 130 may be e.g., a 5G gNB, a 4G eNB, or a radio network node in an alternative 5G radio access technology, e.g., fixed or WiFi. The radio network node 130 may be e.g., a Wide Area Base Station, Medium Range Base Station, Local Area Base Station and Home Base Station, based on transmission power and thereby also coverage size. The radio network node 130 may be a stationary relay node or a mobile relay node. The radio network node 130 may support one or several communication technologies, and its name may depend on the technology and terminology used. The radio network node 130 may be directly connected to one or more networks and/or one or more core networks.

The communications system 100 may cover a geographical area, which in some embodiments may be divided into cell areas, wherein each cell area may be served by a radio network node, although, one radio network node may serve one or several cells. In the example of FIG. 2, the network node 130 serves a cell 141. The network node 130 may be of different classes, such as, e.g., macro eNodeB, home eNodeB or pico base station, based on transmission power and thereby also cell size. In some examples, the network node 130 may serve receiving nodes with serving beams. The radio network node may support one or several communication technologies, and its name may depend on the technology and terminology used. Any of the radio network nodes that may be comprised in the communications system 100 may be directly connected to one or more core networks.

The communications system 100 may comprise a plurality of devices whereof a device 150 is depicted in FIG. 2. The device 150 may be also known as e.g., user equipment (UE), a wireless device, mobile terminal, wireless terminal and/or mobile station, mobile telephone, cellular telephone, laptop with wireless capability, a Customer Premises Equipment (CPE), an Internet of Things (IoT) device, or a sensor, just to mention some further examples. The device 150 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 150 may be wireless, i.e., it may be enabled to communicate wirelessly in the communications system 100 and, in some particular examples, may be able to support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The node 111 may communicate with the another node 112 over a first link 151, e.g., a radio link or a wired link. The node 111 may communicate with the radio network node 130 over a second link 152, e.g., a radio link or a wired link. The radio network node 130 may communicate, directly or indirectly, with the device 150 over a third link 153, e.g., a radio link or a wired link. Any of the first link 151, the second link 152 and/or the third link 153 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 2.

In general, the usage of “first”, “second”, and/or “third” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies.

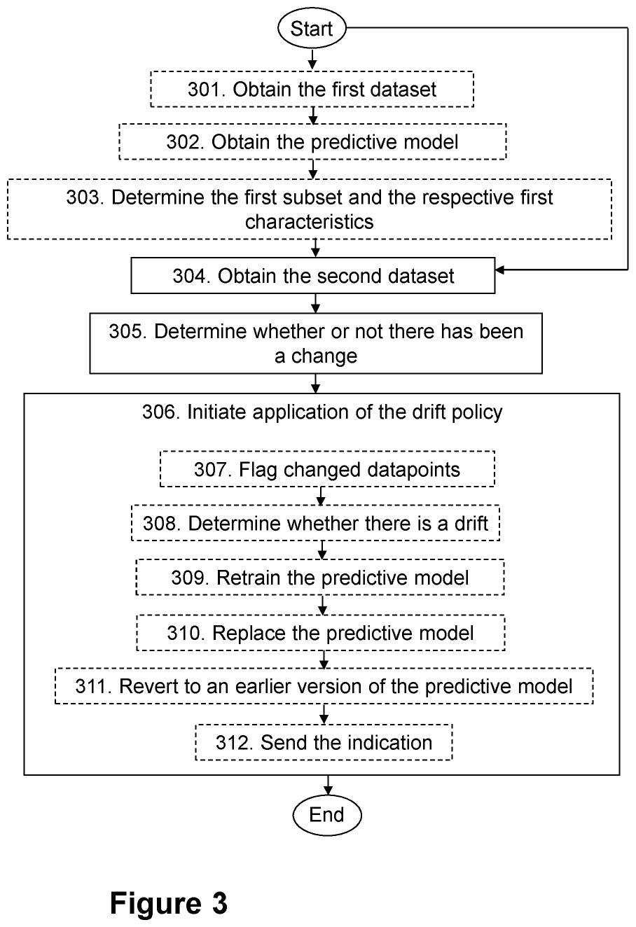

Embodiments of a computer-implemented method, performed by the node 111, will now be described with reference to the flowchart depicted in FIG. 3. The method may be understood to be for handling drift in data. The node 111 operates in the communications system 100.

The method may comprise the actions described below. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the node 111 is depicted in FIG. 3. In FIG. 3, optional actions in some embodiments are represented with dashed lines.

### Action 301

Embodiments herein may be understood to be used in the context wherein one or more dependent variables, e.g., one or more target KPIs, in the communications system 100, may be wished to be analyzed or predicted by, e.g., training a machine learning model.

Embodiments herein may be considered to apply, as a non-limiting example, to the use case of pro-active traffic balancing in network management scenarios may. This use case may typically involve the following steps: prediction of KPI degradation in advance for each cell, recommendation of a neighbouring cell to which traffic may be handed over, and actuation of handover by changing the coverage and/or the antenna tilt.

It may be understood that the ultimate goal of the embodiments herein may be to improve the performance of the communications system 100, or to at least avoid a degradation of its performance. For that ultimate goal, it may be understood to be relevant to ensure that the prediction of the one or more dependent variables of interest may be predicted with accuracy, so that any potential issues may be managed. Hence, any potential drift in data, may need to be addressed, in order to ensure that any predictive model that may be used to predict the one or more variables may have the highest accuracy that may be possible.

In this Action 301, the node 111 may obtain a first dataset. The first dataset may comprise a first plurality of datapoints, which may also be referred to as samples. The first plurality of datapoints may correspond to a first plurality of values of one or more dependent variables, e.g., target KPI(s), for a plurality of first features, e.g., feature KPI(s), over a first time period, e.g., t. The first features may be understood to be independent variables, which may be individual, or groups of variables, hence the term “feature” is used herein to refer to both.

The obtaining in this Action 301 may comprise receiving, e.g., online, the datapoints from a different node in the communications system 100, e.g., from the radio network node 130 and/or from other radio network nodes like it. The receiving of the datapoints may be in a stream, or as a batch. [symbol] The first dataset may comprise, for example, the first plurality of datapoints as a set of k stream samples Xₜ={xₜ¹,xₜ², . . . , xₜ^{k}|xₜⁱ∈ [symbol] ^{m}} with m KPIs, as the plurality of first features, in e.g., a Reporting Operating Periods (ROP) time window t, that is, the first time period. Without loss of generality, the input may also be provided at suitable levels of aggregation in t, e.g., hourly, daily, weekly, monthly etc. The one or more dependent variables may be represented as Yₜ.

By obtaining the first dataset, the node 111 may be understood to be able to analyze and eventually predict the one or more dependent variables, e.g., target KPIs, by for example, calculating a predictive model, as the node 111 may do in the next Action 302.

### Action 302

In this Action 302, the node 111 may obtain a predictive model, e.g., M of the one or more dependent variables, based on the obtained first dataset and the plurality of first features. The expression “based on the obtained first dataset and the plurality of first features” may be understood as using the obtained first dataset. The predictive model M, or a set of active models, may compute predictions Yₜ for all k samples, that is for the first plurality of datapoints. It may be understood that several predictive models, as an active model set, may be processed in parallel or serially. That is, the actions described herein as performed by the node 111 may be performed, e.g., serially or in parallel, for a plurality of predictive models. The set of models may be understood to indicate that there may be multiple models in the pipeline for predicting different dependent variables, e.g., target KPIs. “Active” models may be understood to indicate those models that may be currently being used in the pipeline for prediction.

Obtaining in this Action 302 may comprise any of determining, that is, calculating by the node 111 itself, or retrieving the predictive model from a memory, or receiving the predictive model from a different node in the communications system 100.

For the examples wherein the node 111 may obtain the predictive model by training it itself, the node 111 may use in this Action 302 different machine-learning methods, such as, for example, regression models, neural networks, decision-trees, their variants, among others.

To be able to train the predictive model, the node 111 may, as part of this Action 302 perform data ingestion, e.g., compute KPIs from PM counter data, and feature engineering. Hence, in this Action 302, after stream data ingestion and feature engineering, according to Action 302 the predictive model may be used to compute predictions.

The predictive model, or the model set, may have been trained on the assumption that there is no drift, that is, no change in P(X,y). Optionally, the node 111 may assume that misclassified, or high error rate, samples cause drift. A ‘classification’ setting may be applicable when a threshold may have been defined for one of the one or more dependent variables, and the predictive model may predict the dependent variable as a binary value, e.g., degraded/not degraded, based on it exceeding/not exceeding, or falling below, the specified threshold on the dependent variable. This threshold can be determined by a SME or be based on other heuristics.

Therefore, for accurately predicting the one or more dependent variables, the node 111 may retain erroneously classified samples as {Xₜ*,Yₜ*} where yₜⁱ≠ŷₜ₋₁ⁱ. For forecasting based on regression, the node 111 may obtain {Xₜ*,Yₜ*} where RMSE(yₜⁱ,ŷₜⁱ)≥∈₀. Here, ∈₀ may be a tolerance parameter defined for the acceptable error on the predicted dependent variable. Without loss of generality, these may be considered for previous (t−k) time window(s) or other classification/regression metric(s) based on the specific use-case(s).

By obtaining the predictive model in this Action 302, the node 111 may then be enabled, in the next Action 303, to use explainability and analyze which may be the features with the highest predictive power of the one or more dependent variables and reduce the number of features to monitor for drift, as will be explained later, in relation to Action 305. The node 111 may in turn enable to reduce the amount of computational and time resources to monitor and manage any potential drift when the number of features to monitor may be reduced. The node 111 may therefore be enabled to leverage the use of model predictions in the LCM to determine sample(s) potentially in drift.

### Action 303

In this Action 303, the node 111 may determine, using machine learning and explainability, a first subset of the plurality of first features having a largest contribution to a variability of the datapoints in the first set of datapoints based. The largest contribution may be determined based on a threshold, e.g., 60%, 55%, 50%. That is, in this Action 303, the node 111 may determine which features explain up to 60% of the variability, 55% of the variability, 50% of the variability, etc. . . . Alternatively, instead of a percentage, the threshold may be a number of variables explaining most of the variability, e.g., the top 5 variables, the top 10 variables, etc. . . . The threshold may be understood to be configurable. The variability may be, e.g., the variance, σ².

It may be understood that the subset may comprise fewer first features than the plurality of first features.

In this Action 303, the node 111 may also determine, using machine learning and explainability, respective one or more first characteristics of the first subset of the plurality of first features. The respective one or more first characteristics may be understood to refer to a range of observed values, e.g., minimum to maximum value, distribution of the values, patterns, or relation with and amongst the plurality of first features. That is, statistical metrics of the respective plurality of first features.

The determining in Action 303 of the first subset and the respective one or more first characteristics may be further based on the obtained predictive model in Action 302.

In other words, given a stream of samples comprising of a set of features, that is, the plurality of first features, and target KPI(s), that is, the one or more dependent variables, along with the predictive model(s) being used to compute the target(s), the node 111 may determine, in this Action 303, the relative importance of the first features, e.g., feature KPI(s), in determining the one or more dependent variables, e.g., target KPI(s) by using explainability.

Determining may be understood as calculating or deriving. In one example, the determining in this Action 303 may be realized by examining the aggregated SHapley Additive exPlanations (SHAP) cohort plot of the datapoint(s). Other explainability algorithms, such as e.g., Locally Interpretable Model-agnostic Explanations (LIME) [6] and DeepLIFT [7], may be used in alternative examples.

The node 111 may accordingly, in this Action 303, compute explainability of the stream of samples by computing m SHAP values on {Xₜ*, Yₜ*}, or, fit a locally explainable model Rₜ with parameters {rₜ¹,rₜ², . . . , rₜ^{m}} on {Xₜ*,Yₜ*}. LIME may be understood as a method for computing explainability that may fit a local linear model to a set of samples generated by perturbing the sample(s) for which the explaining features may be required to be computed. If this method is used in the pipeline, the local model parameters may be different from the predicting model of the one or more dependent variables.

As indicated above, optionally, the node 111 may determine, using the threshold described above, or aggregate, the top p(≤m) parameters, or SHAP values, or parameters of the predictive model in R as explaining first features, using a configurable, e.g., user supplied, p. The node 111 may determine the top p explaining first features, either using their corresponding SHAP values, or using the parameters of the locally explainable mode R, if LIME was used. For example, if the node 111 is to examine 10% of first features that change, the node 111 may set p=round(0.1*m). This may be denoted by Rₜ*. The node 111 may then normalize the explainability values of Rₜ* using softmax/unit normalization. This may be referred to as [symbol] . This may be understood to represent the distribution of important first features that may explain the datapoints in the considered first time period, that is, time window t.

This Action 302 may be understood to be performed in the absence of determining whether or not the first plurality of datapoints has a drift. By determining the first subset of the plurality of first features and the respective one or more first characteristics in this Action 303, the node 111 may be enabled identify a number of features among the a plurality of first features of the first dataset that may lead to the prediction of the predictive model. In other words, by the node 111 computing explainability, the node 111 may be allowed to determine which first features may have been important in the predictive model arriving at the predicted one or more dependent variables, e.g., target KPI, using the plurality of first features, e.g., feature KPIs. The node 111 may then be enabled to later use this information, specifically, a significant change in the explaining first features, to identify datapoints with one or more dependent variables, e.g., KPIs, potentially in drift, as will be described later. By being the most relevant for predicting the one or more dependent variables, that is, by having the largest contribution to the variability of the datapoints in the first set of datapoints, these first features may be understood to be those first features being the most likely to contribute to any potential drift that may be observed in future datapoints collected for the one or more dependent variables. This may in turn later enable the node 111 to avoid having to analyze drift of data for all of the plurality of first features, which would be very computationally intensive. Hence, the node 111 may be enabled to facilitate computation of the determination of the drift. The computational cost for the node 111 may therefore be lower, in terms of compute resource and time, than it would otherwise be if the node 111 had to perform brute-force drift detection algorithm(s) on all the samples, that is, all feature(s), target(s) or model error metric(s) independently. Furthermore, the node 111 may then be enabled to perform optimal re-training of the predictive model, by suitably defining the drift resolution policy, in the lifecycle management of predictive models in managed services for networks scenarios.

Further, as explained earlier, the model-based explainability computation may be understood to be advantageous in cases where target KPIs may be influenced by prior feature KPIs. Since the computation of explainability values may be based on model predictions on the one or more dependent variables using first features from previous time instants, the node 111 may be enabled to determine drift for cases when drift in the one or more dependent variables, e.g., target KPI, may be due to drift in the plurality of first features, e.g., feature KPIs, at other time instants, that is, in other time periods, which may be reflected in the predictions of the predictive model, as will be described later. This may be beneficial for network management scenarios for KPIs computed from Performance Management (PM) counters data. This may be understood to be because KPIs in a network management setting may be typically real numbers, unlike categorical targets in classification.

### Action 304

In this Action 304, the node 111 obtains a dataset, that is, a new dataset, comprising a plurality of datapoints corresponding to a plurality of values of the one or more dependent variables for the plurality of first features over a time period. The obtained dataset may be understood to be a second dataset, the plurality of datapoints may be understood to be a second plurality of datapoints, the plurality of values may be understood to be a second plurality of values, and the time period may be understood to be a second time period.

In the course of operations of the communications system 100, one or more actuations may have been executed because of the predictive model predictions fj at time t. An actuation may be understood to refer to a physical action executed based on a prediction by the predictive model. In the network management setting, examples of actuation may be traffic load being handed over to neighbouring cells, an antenna tilt being adjusted to rectify degradation in signal strength KPIs, as determined by a model employed for predicting KPIs, etc. . . . In some embodiments, the obtaining in this Action 304 of the (second) dataset comprising the (second) plurality of datapoints may be performed after an actuation executed based on the obtained predictive model in Action 302. The expression “based on the obtained predictive model” may be understood to mean here, e.g., triggered by a prediction made by the predictive model.

The obtaining in this Action 304 may comprise receiving, e.g., online, the datapoints from a different node in the communications system 100. e.g., from the radio network node 130 and/or from other radio network nodes like it. The receiving of the datapoints may be in a stream, or as a batch.

By the node 111 obtaining the second dataset in this Action 304, the node 111 may be enabled to monitor whether there may be any changes in the behavior of the one or more dependent variables, which may require initiating a drift policy, such as for example, a change to the predictive model, such as retraining, replacement or reverting to an earlier version of the predictive model, as will be described in the next actions. Hence, the node 111 may in turn be enabled to ensure that it may be able to monitor and predict the one or more variables with the highest accuracy, thereby ensuring that performance of the communication system 100 may be dynamically monitored and optimized.

### Action 305

After the predictive model may have been obtained, e.g., trained and validated, either by the node 111 itself, or by a different node operating in the communications system 100, a change in the plurality of datapoints, e.g., KPI patterns, corresponding to the one or more dependent variables may occur due to various environmental factors or traffic movement. Alternatively, KPI patterns may also change as a result of the actuations mentioned above. Change in the plurality of datapoints, e.g., KPIs, may affect performance of the predictive model. In such cases, the node 111, according to embodiments herein, may look at deviations in explainability, to see whether the explainability computed on the second dataset, which may be referred to as a streaming dataset, may deviate from a reference, or global, set of explainability values computed on the first dataset, which may be referred to herein as the reference dataset. Global explainability may be understood to refer to explanation of the learning algorithm, including the first dataset used, appropriate uses of the algorithms, and warnings regarding weaknesses of the algorithm and inappropriate uses. In embodiments herein, the reference or global set of explainability values may be understood to be the first subset of the plurality of first features and the respective first characteristics of the first subset of the plurality of first features, as determined in Action 303.

According to the foregoing, in this Action 305, the node 111 determines, using machine learning and explainability, in the absence of determining whether or not the plurality of datapoints has a drift, whether or not there has been a change in respective one or more characteristics, that is, respective one or more second characteristics, of a subset, that is, a second subset, of the plurality of first features in the plurality of datapoints, that is the second plurality of datapoints, having a largest contribution to a variability of the datapoints in the plurality of datapoints, that is the second plurality of datapoints, based on the threshold, from the first time period to the second time period. The first time period may be understood to be when the first dataset from Action 301 may have been collected, and the second time period may be understood to be when the second dataset from Action 304 may have been collected.

The threshold may be configured on a case by case basis, to set which may be the amount of change that may be considered to be significant.

The expression “in the absence of determining whether or not the plurality of datapoints has a drift” may be understood to mean that the determining in this Action 305 is performed before drift detection may be performed, that is pre-hoc.

Determining may be understood as calculating or deriving.

The determining in this Action 305 of whether or not there has been a change may be based on comparing the determined first subset and the respective one or more first characteristics with the second subset and the respective one or more second characteristics.

The determining in Action 303 of the first subset and the respective one or more first characteristics, and the determining in this Action 305 of the second subset and the respective one or more second characteristics may be further based on the obtained predictive model.

For example, the actuations that may have been executed because of the predictive model predictions ŷₜ at time t may be affected by a change in the distribution of first features P(ŷₜ|xₜ₋ₖ) in ‘k’ prior instants of time. Embodiments herein may use explainability to detect a significant change in explaining features to trigger a drift detection/resolution policy in the LCM pipeline.

By determining whether or not there has been a change in which first features are comprised in the first subset and in the second subset and in their respective one or more respective characteristics of the subset of the plurality of first features in the plurality of datapoints having the largest contribution to the variability of the datapoints, from the first time period to the second time period, the node 111 may be able to assess whether one or more of the one or more dependent variables at a current time instant, the second time period, may be affected by first feature(s) at other time instants, e.g., the first time period, for network management use-cases. By the node 111 performing this assessment using explainability pre-hoc, that is, in the absence of, that is, before, determining whether or not the plurality of datapoints has a drift, the node 111 may be enabled to trigger a drift resolution policy on a specific set of the first feature(s) or sample(s), which specific set may be understood to be a reduced set. If this may be empirically substantiated, the node 111 may then use deviated local interpretability to trigger, for example, retraining of the predictive model, by choosing samples for drift handling, as part of drift handling, or management, policy. The node 111 may be understood to advantageously perform this assessment unlike conventional methods, that may use explainability post-hoc to analyze the cause(s) of drift. As drift detection algorithms may typically use statistical measures to estimate difference in distribution of data in time windows, it may be understood to limit the understanding of practitioners on the cause of the drift, for which explainability may be leveraged post-hoc in conventional settings. However, as embodiments herein may employ drift selection driven by explainability, an understanding of the contributing features may be inferred.

Embodiments herein may be understood to leverage the use of model predictions in the LCM to determine sample(s) potentially in drift. This may be understood to have two advantages. Firstly, the computational cost of running drift detection algorithms on all the datapoints, e.g., all the feature(s), target(s), or model error metric(s) which may be conventionally done to detect drift, may be understood to be reduced. Secondly, drift in the one or more dependent variables, that is, target variable(s), may be correlated to drift in the first feature(s) by implicitly using explainability values, which may be understood to justify the premise of drift detection in network management scenarios. The proposed approach may be understood to provide an optimal way to detect drift efficiently and subsequently resolve it.

Unlike existing methods, wherein drift is determined by continuously monitoring the performance index parameters exceeding specific threshold(s), the node 111 may be understood to allow for robust drift detection when the one or more dependent variables, e.g., target KPIs, may be affected, that is, drifted, due to change in the plurality of first features, e.g., feature KPIs, which may be captured by explanations based on the predictive model. For example, Physical Resource Block utilization, Downlink Block Error Rate and Physical Downlink Control Channel utilization may be examples of feature KPIs that may be important in determining how a target KPI such as downlink throughput may have degraded, that is, drifted from the first time period to the second time period, and these determining features may be identified by computing explainability of the plurality of first features, e.g., feature KPIs, using the predictive model responsible for predicting the one or more dependent variables, e.g., target KPI, using these subset of the plurality of first features, e.g., features.

### Action 306

In this Action 306, the node 111 initiates application of a drift policy on the plurality of datapoints, that is, the second plurality of datapoints, based on a result of the determination of whether or not there has been a change.

To initiate may be understood as begin the application itself, or to enable or facilitate that a different node may perform the application of the drift policy.

As stated earlier, the drift policy may be understood to refer to the one or more methods that may be adopted to mitigate the effects of drift. In the intended use-case here of network management, examples of drift policy may include, for example, model re-training, as described in Action 309, model replacement, as described in Action 310, all or selected, in case of ensemble predictive models, reverting to an earlier version of a model, as described in Action 311, or sending an indication, as described in Action 312, among others. The initiating of the application in this Action 306, that therefore comprise selecting the drift policy to be applied, e.g., based one or more criteria, e.g., rules.

By initiating application of the drift policy in this Action 306, the node 111 may therefore be enabled to mitigate, or manage, the effects of the drift.

In some embodiments, the initiating in Action 306 of the application of the drift policy may comprise that the node 111 may perform Action 307 and Action 308.

### Action 307

In some embodiments, the initiating in Action 306 of the application of the drift policy may comprise that the node 111 may, in this Action 307, flag any datapoints wherein it may have been determined to have been change. In other words, when there may be a significant change in the set of feature(s) explaining the target KPI(s) as determined in Action 303 above, the node 111 may flag these samples for potential drift. Significance may be established based on the threshold. Flagging may be understood as identifying or selecting.

By, in this Action 307, flagging the datapoints wherein there may have been a change, the node 111 may use a change in for example a distribution(s) of the plurality of first features with respect to the one or more dependent variables, as determined by explainability values, to flag samples for potential drift resolution in network management use-cases. Thus, any potential drift may be enabled to be further investigated and any remedial actions taken to mitigate the drift, either by updating the predictive model, retraining, reverting to an earlier version, or sending an indication, as explained later.

### Action 308

In some embodiments, the initiating in Action 306 of the application of the drift policy may comprise that the node 111 may, in this Action 308, determine whether or not there may be drift using only the flagged datapoints. A suitable drift detection algorithm(s) may be used to perform this Action 308, such as, e.g., Page Hinkley [2] and HDDM_A [3].

The node 111 may trigger drift detection and/or resolution when ƒ( [symbol] , [symbol] )→1, where ƒ may be understood to be a function that may output a normalized measure of the relative change in explainable features. The node 111 may initiate the drift policy when there may be a significant change in the explaining features. This may be quantified by a suitable function ƒ, that may have a value close to 1 when the change is significant, and close to 0 otherwise. Such a function may be used in the pipeline to automatically identify when to initiate the drift policy. This may be extended to previous time window(s) t−k as well. In alternative examples, such a function ƒ may be used with change in label distributions, or with different set(s) of the one or more dependent variables and the first features, e.g., of target and feature KPI(s), to trigger drift detection or resolution pipeline(s).

By determining whether or not there may be drift using only the flagged datapoints in this Action 308, the node 111 may be enabled to perform a drift detection which may be understood to involve less computation than conventional approaches. In conventional settings, drift detection would involve running a drift detection algorithm either on the KPIs used as features for training the model, or on the target KPI, which may be predicted by the model, or on the error values computed between the predicted and actual KPI values, where known. The drift detector would need to be run on/for all the data points. Therefore, by performing Action 308, the node 111 may avoid having to run a drift detector on all datapoints.

In some embodiments wherein drift may be determined to have occurred in the flagged datapoints, the initiating in Action 306 of the application of the drift policy may comprise that the node 111 may perform at least one of Action 309, Action 310 and Action 311, which are described next. In other words, a suitable mitigation strategy, e.g., model re-training or replacement, may be employed in the LCM for suitable mitigation of the consequences of drift on the flagged sample(s) or the features comprising them.

The approach of embodiments herein may be understood to not be specifically constrained on any drift detection or explainability computation method. Although the specific examples that may be shown herein may use a Page Hinkley or an Hoeffding Drift Detection Method (HDDM) drift detector and SHAP cohort plots for analysis, it may be possible to use any alternative drift detection method or global or local explainability computation technique in the pipeline. The approach may potentially lead to improved LCM for various MSN use-cases. In embodiments herein, the node 111 may be understood to leverage a change in local explanations, among drifted KPIs, compared to global, non-drifted, KPIs, to identify potential KPI samples in drift. When the node 111 may determine explainability of KPIs using the predictive model with data points of a specified time window, the node 111 may be understood to determine local explainability, with reference to those samples.

Since explainability may be understood to be determined by the output of the predictive model on the plurality of data points, that is, samples, explainability values, such as SHAP values may be considered as representative of the contributing features for the samples considered. Hence, computing explainability may be understood to be a “sample-based” or model based approach and may be understood to allow determining the resolution policy based on the drifting one or more dependent variables, e.g., KPIs.

### Action 309

In some embodiments, the initiating in Action 306 of the application of the drift policy may comprise that the node 111 may, in this Action 309, retrain the obtained predictive model based on the determined drift.

The expression “based on the determined drift” in this Action 309 may be understood to mean that the node 111 may retrain the obtained predictive model with the proviso that drift may have been detected, and to refrain from training the obtained predictive model otherwise. Furthermore, in examples wherein the node 111 may retrain the obtained predictive model, the node 111 may perform the retraining using the information learned from the drift detection. The node 111 may update the predictive model parameters by running the training algorithm of the predictive model with, or without, the datapoints identified to be in drift in the dataset for the time window.

By retraining the obtained predictive model in this Action 309, the node 111 may be enabled to ensure that that the obtained predictive model avoids losing its accuracy, and may continue to be relied on in order to make predictions on the one or more dependent variables in the communications system 100, which may be understood to improve management of its performance.

### Action 310

In some embodiments, the initiating in Action 306 of the application of the drift policy may comprise that the node 111 may, in this Action 310, replace the obtained predictive model by another predictive model based on the determined drift.

Replacing may be understood to mean as substituting by a different predictive model.

The expression “based on the determined drift” in this Action 310 may be understood to mean that the node 111 may replace the obtained predictive model with the proviso that drift may have been detected, and to refrain from replacing the obtained predictive model otherwise. Furthermore, in examples wherein the node 111 may replace the obtained predictive model, the node 111 may perform the replacing using the information learned from the drift detection. The node 111 may train another predictive model using the datapoints identified to be in drift and this may replace, e.g., an existing model in the “active” set, those that may be used for predicting the one or more variables.

By replacing the obtained predictive model in this Action 310, the node 111 may be enabled to ensure that that the predictive model used to manage the performance of the communications system 100 is that with the highest accuracy, and may be relied on in order to make predictions on the one or more dependent variables in the communications system 100, which may be understood to improve management of its performance.

### Action 311

In some embodiments, the initiating in Action 306 of the application of the drift policy may comprise that the node 111 may, in this Action 311. revert to an earlier version of the obtained predictive model based on the determined drift.

The expression “based on the determined drift” in this Action 311 may be understood to mean that the node 111 may revert to the earlier version of the obtained predictive model with the proviso that drift may have been detected, and to refrain from reverting to the earlier version of the obtained predictive model otherwise. Furthermore, in examples wherein the node 111 may revert to the earlier version of the obtained predictive model, the node 111 may perform the reverting using the information learned from the drift detection. In this case, the identified drift may be recurrent, that is, a similar type of drift may have been found previously, for which a predictive model may also have been trained and deployed. In such cases, the node 111 may directly use that model without the need to re-train or update any existing model from the active set. It may be understood that the earlier version may have had a higher accuracy than the current version.

By reverting to the earlier version of the obtained predictive model the obtained predictive model in this Action 311, the node 111 may be enabled to ensure that that the predictive model used to manage the performance of the communications system 100 is that with the highest accuracy, and may be relied on in order to make predictions of events in the communications system 100, which may be understood to improve management of its performance.

Furthermore, re-training or replacement cost may be avoided.

### Action 312

In some embodiments wherein drift may have been determined to have occurred in the flagged datapoints, the initiating in Action 306 of the application of the drift policy may further comprise that the node 111 may, in this Action 312, send an indication to another node 112 operating in the communications system 100 to indicate the detected drift.

The indication may indicate performance of an actuation action. The indication may be, for example, an alarm to raise awareness of the detected drift, an instruction to adjust an antenna tilt in a base station, an instruction to handover load to a different base station or part of the communications system 100, etc.

By sending the indication to the another node 112, the node 111 may initiate performance of the action to manage the detected drift, which may be indicative of a malfunction in hardware within the communications system 100, or of mismanagement of traffic, etc. . . . The node 111 may therefore be enabled to facilitate an improved management and performance of the communications system 100.

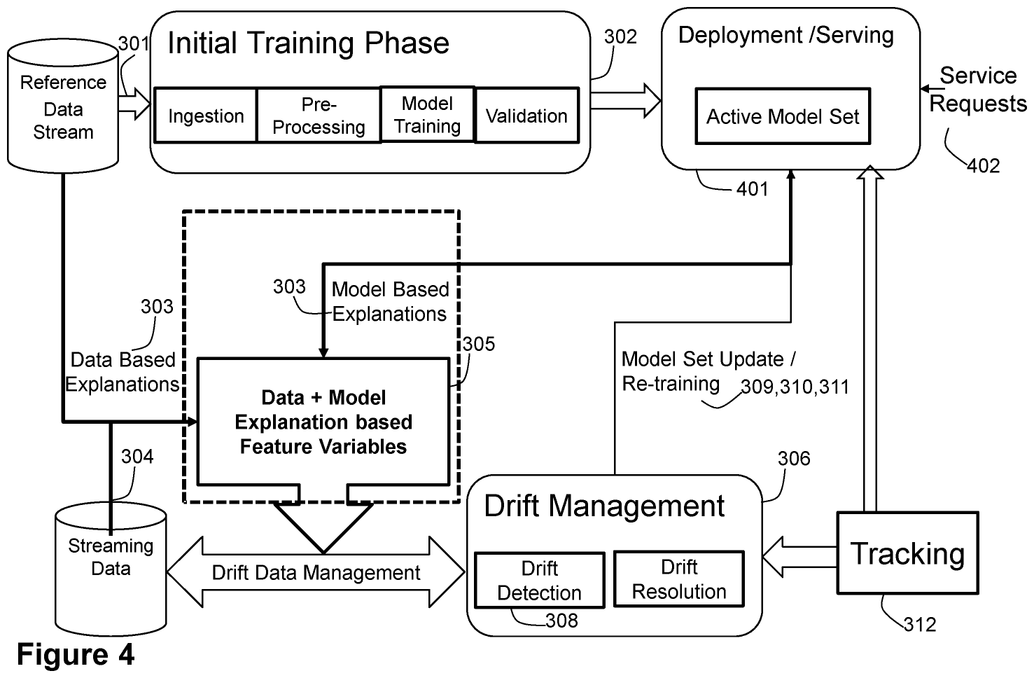

FIG. 4 is a schematic diagram depicting a summary workflow of the method performed by the node 111 according to embodiments herein for explainability-driven drift policy selection for network management. The node 111 obtains the first dataset of streaming data in accordance with Action 301, and, in accordance with Action 302 initiates the training phase of the predictive model. This phase comprises ingestion and pre-processing of the datapoints, followed by training of the predictive model, and validation of the trained predictive model. Once the predictive model is obtained, or the plurality of predictive models, at 401, one or more of the predictive models may be deployed in production, and those models may constitute the active set. At 402, service requests in the production environment may be received to predict one or more target KPIs using the models in the active set. The node 111 may then, in accordance with Action 303, determine, using machine learning and explainability the first subset of the plurality of first features and the respective first characteristics of the first subset of the plurality of first features. “Data-based explanation” may involve at evaluating statistical measures computed on a feature KPI to determine drift, while a “model-based explanation” may involve comparing model parameters to identify drift. However, when the node 111 may use explainability, the node 111 may be understood to be looking at the feature KPIs vis-à-vis the model predictions of the target KPI(s), thus incorporating a data+model-based approach. The node 111 may also obtain the second dataset in accordance with Action 304, denoted as “streaming data” in FIG. 4, and in accordance with Action 305, the node 111 may determine whether or not there has been a change in the second set of first features and in the respective one or more second characteristics of the second subset of the plurality of first features. The node 111 may then be able to, in accordance with Action 306, initiate application of the drift policy, by managing any drift, if detected. In accordance with Action 308, the node 111 may perform drift detection, that is, may determine whether or not there may be drift using only the datapoints it may have flagged. If drift is detected, the node 111 may then perform drift resolution by retraining or updating the predictive model in accordance with Action 309, by replacing the predictive model in accordance with Action 310 or by reverting to an earlier version of the predictive model in accordance with Action 311. The node 111 may alternatively or additionally send the indication to the second node 112 in accordance with Action 312. It may be noted that embodiments herein may employ explainability pre-hoc, as compared to conventional approaches, which may use explainability for post-hoc drift analysis. This may be understood to help to identify cases when drift in KPI(s) at a current time instant may occur due to drift in KPI(s) at previous time instants. Hence, using explainability, derived from model predictions, may capture this. The node 111 may also enable to reduce the set of sample(s) or feature(s) on which drift detection would otherwise be run in a conventional setting, thereby saving on computational cost. Explainability may be understood to also offer feedback for human intervention in the LCM pipeline, as explainability may be understood to provide interpretable feedback.

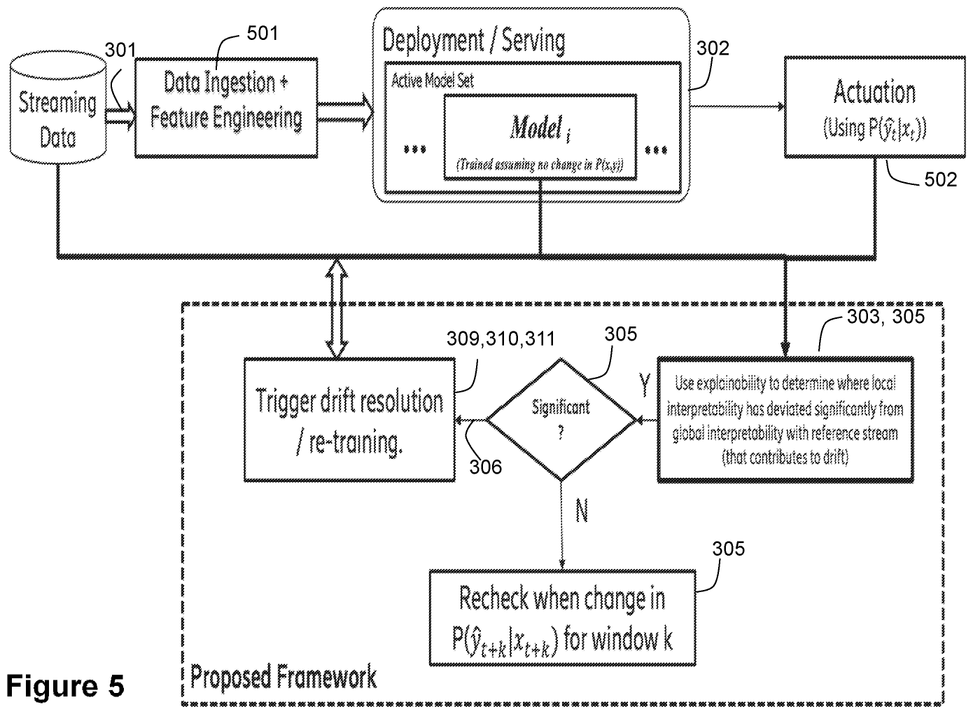

FIG. 5 is schematic diagram depicting further details of the method performed by the node 111 according to embodiments herein. According to Action 301, the node 111 obtains as input a set of k stream samples Xₜ={xₜ¹,xₜ², . . . , xₜ^{k}|xₜⁱ∈ [symbol] ^{m}} with m KPIs, that is, first features, in the first time period, that is, a ROP time window t. Without loss of generality, the input may also be provided at suitable levels of aggregation in t, e.g., hourly, daily, weekly, monthly etc. The datapoints, at 501, as part of Action 302, undergo data ingestion and feature engineering. After stream data ingestion and feature engineering, the node 111 may obtain the predictive model according to Action 302. The predictive model M, or set of active models, may compute predictions Yₜ for all k samples. This predictive model, or model set, set may be understood to have been trained on the assumption that there is no drift, no change in P(X,y). However, at 502, the actuations executed because of the predictive model predictions ŷₜ at time t affects P(ŷₜ|xₜ₋ₖ). The node 111 may compute explainability of the stream of samples, according to Action 303 and Action 305, to determine where local interpretability may have deviated significantly from the global interpretability with the first dataset, that may contribute to the drift. When the deviation is significant, the node 111, initiates, according to Action 306 application of a drift policy. In accordance with Action 308, the node 111 may perform drift detection, that is, may determine whether or not there is drift using only the datapoints it may have flagged. If drift is detected, the node 111 may then perform drift resolution by retraining or updating the predictive model in accordance with Action 309, by replacing the predictive model in accordance with Action 310 or by reverting to an earlier version of the predictive model in accordance with Action 311. The node 111 may alternatively or additionally send the indication to the second node 112. If the determined change is not significant, the node 111 may recheck when P(ŷₜ₊ₖ|xₜ₊ₖ) for window k.

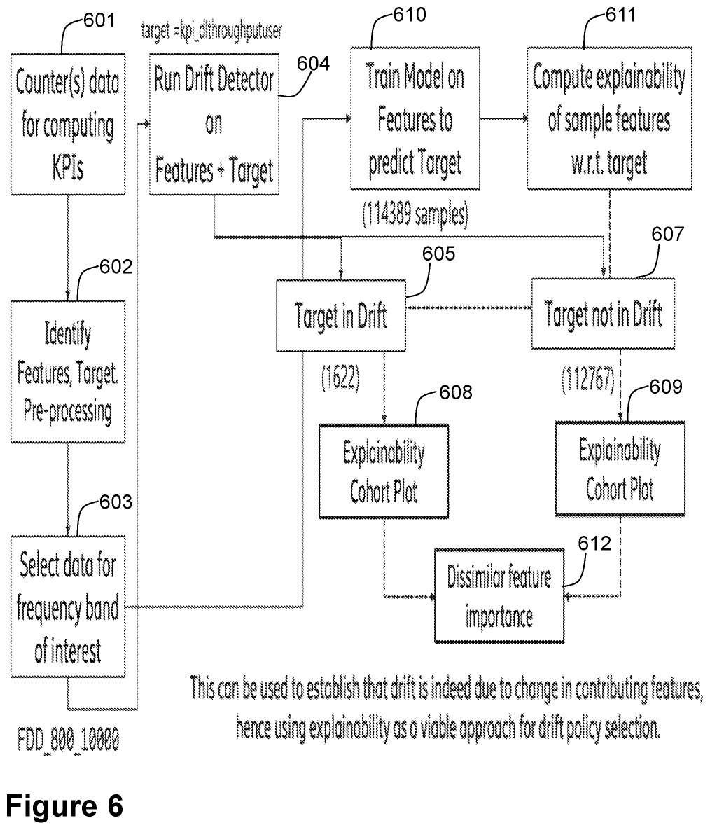

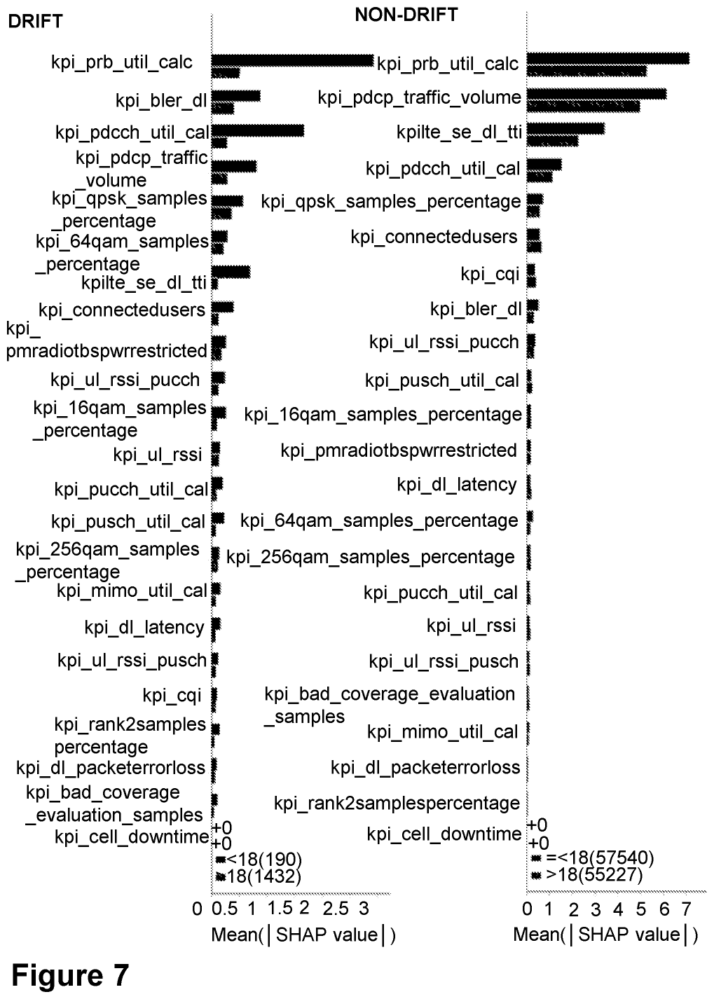

An experiment was conducted to analyze the validity of the method described herein. FIG. 6 is a schematic representation depicting functional modules of the experiment that was performed to validate the approach of embodiments herein. The intent of the experiment was to validate the hypothesis that there is indeed a change in the explaining first features for samples in drift, compared to those not in drift. This may be understood to validate in turn the use of explainability as a viable measure to detect sample(s) and/or feature(s) in potential drift, particularly in use-cases related to MSN, where the target(s) drift may depend on drift in feature(s) at other time instants. This hypothesis was validated on PM counter data for a duration of 1 month collected at 15 minute ROP. The raw counter data obtained at 601 was processed at 602 to obtain a set of 23 KPIs which were used as first features, and a target KPI which was the user downlink throughput: kpi_dlthroughputuser. Data were selected of a specific frequency band for analysis as indicated at 603 in FIG. 6, FDD_800_10000, the 800 MHz frequency band, which had 114,389 samples. Two drift detection algorithms were run, viz. Page Hinkley [2] and HDDM_A [3] on the target KPI to determine the samples where the target KPI was in drift. Once the drift detection algorithm had been run at 604, the samples were segregated based on whether the target was in drift or not. For the example, using Page Hinkley drift detector shown in FIG. 6, 1,622 samples were found at 605 where the target KPI was in drift, and 112,767 samples otherwise at 607. The SHAP values for the two sets of samples identified were then computed, and the aggregated SHAP cohort plot obtained at 608 and 609, respectively, by thresholding the target KPI at a value of 18.0, e.g., provided by an SME. These plots for the two sets of samples are shown in FIG. 7 for the Page Hinkley algorithm. The selected data were used to train a model on the features to predict the target feature at 610. It may be noted here that explainability values were computed in this case at 611 after segregating the samples using a drift detection algorithm. This was done to validate the hypothesis at 610 that there would be a change in the explaining features for the two cases. That is, as depicted in FIG. 6, the experiment was used to establish that drift is indeed due to a change in contributing features at 612. Hence, using explainability may be understood to be a viable approach for drift policy selection. In actual embodiments herein, the change in explainability values for the features in different time windows would be used to flag samples, and/or features, for triggering a suitable drift detection policy in the LCM pipeline.

FIG. 7 is a schematic representation depicting the results of the experiment to validate the approach of embodiments herein. FIG. 7 depicts SHAP cohort plots using the Page Hinkley Drift Detector. The different feature KPIs are depicted in the vertical axis. The mean |SHAP value| is depicted on the horizontal axis. For every feature KPI, the top bar indicates the Mean |SHAP value| for datapoints corresponding to the indicated feature KPI having a corresponding value of the dependent KPI, here, user downlink throughput equal or inferior to 18, considered to be “poor”. The bottom bar indicates the Mean |SHAP value| for datapoints corresponding to the indicated feature KPI having a corresponding value of the dependent KPI exceeding 18, considered to be “good”. It may be appreciated from FIG. 7 that although the most explaining feature Physical Resource Block (PRB) utilization (kpi_prb_util_calc) is common for both cases, that is, samples with target in drift, depicted on the left, and without, depicted on the right, there is a change in the subsequent explaining features. For the samples where the target KPI is in drift, the explaining features include downlink Block Error Rate (kpi_bler_d), Physical Downlink Control Channel utilization (kpi_pdcch_util_cal) and Packet Data Convergence Protocol traffic volume (kpi_pdcp_traffic_volume), while for those where the target is not in drift, the order of explaining features is kpi_pdcp_traffic_volume, LTE downlink transmission time interval (kpilte_se_dl_tti) and kpi_pdcch_util_cal. The effective importance of these features for the samples thresholded on the target variable may also be seen in the respective plots, which may also change for the two cases considered. Other depicted features are: Quadrature Phase Shift Keying samples percentage (kpi_qpsk_samples_percentage), 64 Quadrature Amplitude Modulation (QAM) samples percentage (kpi_64qam_samples_percentage), Scheduled UE Downlink TTI (kpifte_se_dl_tti), Number of connected user (kpi_connectedusers), the count of the number of Transport Blocks on MAC level scheduled in uplink where the UE was considered to be power limited (kpi_pmradiotbspwrrestricted), Uplink Received Signal Strength Indicator (RSSI) Physical Uplink Control Channel (PUCCH) (kpi_ul_rssi_pucch), 16 QAM samples percentage (kpi_16qam_samples_percentage), Uplink RSSI (kpi_ul_rssi), PUCCH utilization (kpi_pucch_util_cal), Physical Uplink Shared Channel (PUSCH) utilization (kpi_pusch_util_cal), 256 QAM samples percentage (kpi_256qam_samples_percentage), Multiple-Input Multiple-Output utilization (kpi_mimo_util_cal), Downlink latency (kpi_dl_latency), Uplink RSSI PUSCH (kpi_ul_rssi_pusch), Channel Quality Indicator (kpi_cqi), Rank 2 samples percentage (kpi_rank2samplespercentage), Downlink packet error loss(kpi_dl_packeterrorloss), Bad coverage (kpi_bad_coverage), Bad coverage evaluation samples (kpi_bad_coverage_evaluation_samples), and Cell downtime (kpi_cell_downtime).

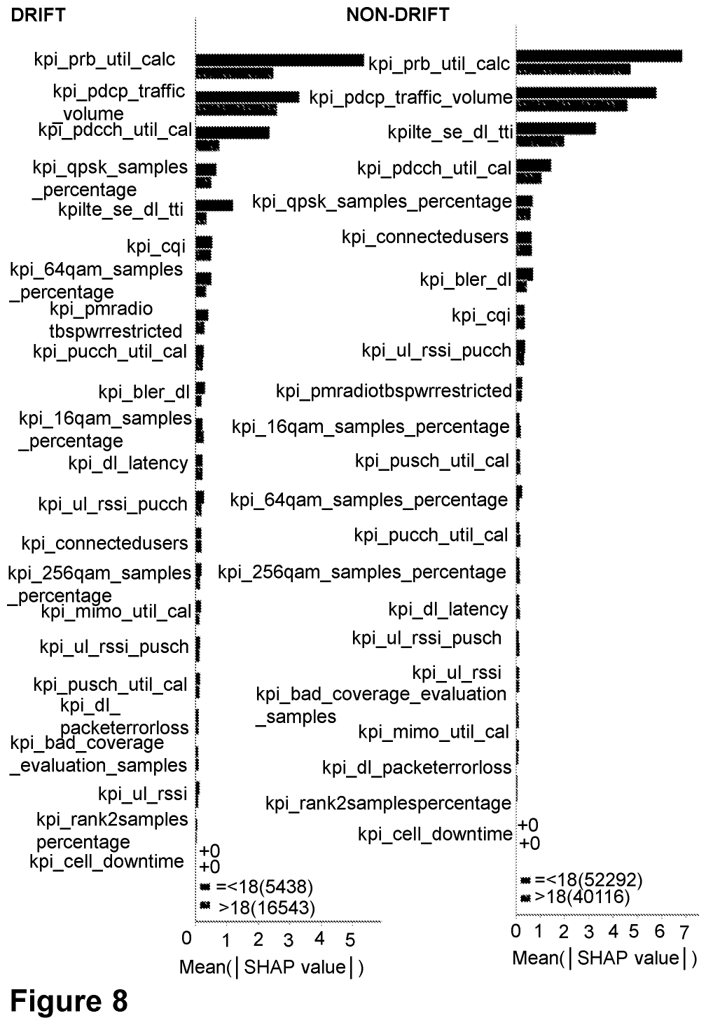

Further validation in this direction using an alternative drift detection algorithm (HDDM_A) was also conducted and the corresponding aggregated SHAP cohort plots are shown in FIG. 8. FIG. 8 depicts SHAP cohort plots using the HDDM_A Drift Detector in a same manner otherwise, to how they are depicted in FIG. 7. Here too, it may be observed that for the samples where the target is in drift, the explaining features, excluding the top two explaining features, include kpi_.pdcch_util_cal and percentage of samples in quadrature phase shift keying (kpi_qpsk_samples_percentage), while those for samples where target is not in drift include kpilte_se_dl_tti and kpi_.pdcch_util_cal. This change in the set of explaining features may be understood to validate the approach of embodiments herein, which may be understood to envisage the use of explainability measures computed on samples with their model predictions to flag samples for further processing by a drift detection pipeline. The remaining feature KPIs depicted in FIG. 8 correspond to those depicted in FIG. 7.

Certain embodiments disclosed herein may provide one or more of the following technical advantage(s), which may be summarized as follows. Embodiments herein may be understood to enable efficient drift policy selection, based on defined criteria, by using feature, e.g., KPI, based explainability driven drift policy selection. In ML workflows for network management, KPI computation using time series data from counters may be affected by drift, e.g., post COVID or occurrence of events resulting in large gathering of people or UEs. This may be understood to affect network utilization, model performance, and may mandate re-training. Embodiments herein may use explainability to identify changes in feature distribution with respect to target(s) and may use such a change in explaining features to trigger drift detection/resolution policy.

A second advantage of embodiments herein may be understood to be that by using pre-hoc explainability instead of post-hoc drift analysis, the need to run drift detection on all samples is avoided, and the computational cost is reduced. This is since the drift detection may only need to be run on samples where the set of features that explain the target prediction by the model may have changed. This is contrast with existing drift detection algorithms, which may be understood to run on all data, features and targets to flag samples in drift, which are then used/discarded in model re-training. This is computationally expensive, and sub-optimal in LCM workflows for network management.

Explainability computation according to embodiments herein may be understood to use the predictive model, or the active model(s) in the loop, hence leveraging the availability of the predictive model, or the active model set, which may be responsible for computing predictions on samples. Hence explainability computation may be understood to be inherently facilitated. This cost may be understood to be lower, in terms of compute resource and time, than evaluating drift detection algorithm(s) on all feature(s), target(s) or model error metric(s) independently would otherwise be.

Furthermore, embodiments herein may be understood to provide better drift management in network services frameworks by enabling to use explainability to identify features in drift due to possible drift in the target feature.

Furthermore, embodiments herein may be understood to potentially lead to improved LCM by reducing human intervention as potential feedback loop to analyze changes in the network that may have resulted due to the drift.

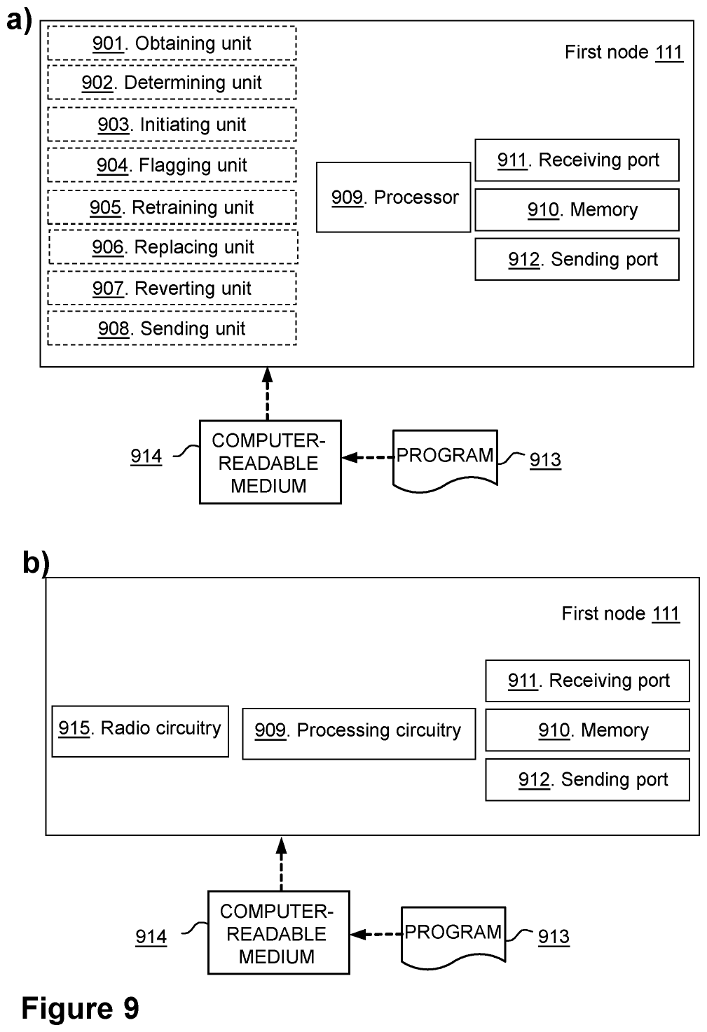

FIG. 9 depicts two different examples in panels a) and b), respectively, of the arrangement that the node 111 may comprise to perform the method actions described above in relation to FIG. 3, and/or FIGS. 4-5. In some embodiments, the node 111 may comprise the following arrangement depicted in FIG. 9a. The node 111 may be understood to be for handling drift in data. The node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 9, optional boxes are indicated by dashed lines. The detailed description of some of the following corresponds to the same references provided above, in relation to the actions described for the node 111 and will thus not be repeated here. For example, the one or more dependent variables may be target KPIs and the first plurality of first features may be feature KPIs.

The node 111 is configured to, e.g. by means of an obtaining unit 901 within the node 111 configured to, obtain the dataset configured to comprise the plurality of datapoints configured to correspond to the plurality of values of the one or more dependent variables for the plurality of first features over the time period.

The node 111 is also configured to, e.g. by means of a determining unit 902 within the node 111 configured to, determine, using machine learning and explainability, in the absence of determining whether or not the plurality of datapoints has a drift, whether or not there has been a change. The change is configured to be in the respective one or more characteristics of the subset of the plurality of first features in the plurality of datapoints configured to have the largest contribution to the variability of the datapoints in the plurality of datapoints based on the threshold from the first time period to the second time period.

The node 111 is further configured to, e.g. by means of an initiating unit 903 within the node 111 configured to, initiate application of the drift policy on the plurality of datapoints based on the result of the determination of whether or not there has been a change.

In some embodiments the dataset configured to be obtained may be configured to be the second dataset. The plurality of datapoints may be configured to be the second plurality of datapoints, the plurality of values may be configured to be the second plurality of values, the subset may be configured to be the second subset, the respective one or more characteristics may be configured to be the respective one or more second characteristics and the time period may be configured to be the second time period. In some of such embodiments, the node 111 may be further configured to, e.g. by means of the obtaining unit 901 within the node 111 configured to, obtain the first dataset. The first dataset is configured to comprise the first plurality of datapoints configured to correspond to the first plurality of values of the one or more dependent variables for the first plurality of features over the first time period.

In such embodiments the node 111 may be further configured to, e.g. by means of the determining unit 902 within the node 111 configured to, determine, using machine learning and explainability: i) the first subset of the first plurality of features configured to have the largest contribution to the variability of the datapoints in the first set of datapoints based on the threshold, and ii) the respective one or more first characteristics of the first subset of the first plurality of features. The determining of whether or not there has been a change may be configured to be based on comparing the determined first subset and the respective one or more first characteristics with the second subset and the respective one or more second characteristics.

In some of such embodiments, the node 111 may be further configured to, e.g. by means of the obtaining unit 901 within the node 111 configured to, obtain the predictive model of the one or more dependent variables, based on the obtained first dataset and the first plurality of features. The determining of the first subset and the respective one or more first characteristics, and the determining of the second subset and the respective one or more second characteristics may be further configured to be based on the predictive model configured to be obtained.

In some embodiments, the initiating of the application of the drift policy may be further configured to comprise, e.g. by means of a flagging unit 904 within the node 111 configured to, flagging any datapoints wherein the node 111 may be configured to have determined there has been change.

In some of such embodiments, the initiating of the application of the drift policy may be further configured to comprise, e.g. by means of the determining unit 902 within the node 111 configured to, determining whether or not there is drift using only the flagged datapoints.

In some embodiments wherein drift may be determined to have occurred in the flagged datapoints, the initiating of the application of the drift policy may be further configured to comprise at least one of the following three embodiments.

In some embodiments wherein drift may be determined to have occurred in the flagged datapoints, the initiating of the application of the drift policy may be further configured to comprise, e.g. by means of a retraining unit 905 within the node 111 configured to, retraining the predictive model configured to be obtained based on the drift configured to be determined.

In some embodiments wherein drift may be determined to have occurred in the flagged datapoints, the initiating of the application of the drift policy may be further configured to comprise, e.g. by means of a replacing unit 906 within the node 111 configured to, replacing the predictive model configured to be obtained by another predictive model based on the drift configured to be determined.

In some embodiments wherein drift may be determined to have occurred in the flagged datapoints, the initiating of the application of the drift policy may be further configured to comprise, e.g. by means of a reverting unit 907 within the node 111 configured to, reverting to the earlier version of the predictive model configured to be obtained based on the drift configured to be determined.

In some embodiments, the obtaining of the dataset comprising the plurality of datapoints may be configured to be performed after the actuation configured to be executed based on the predictive model configured to be obtained.

In some embodiments wherein drift may be configured to be determined to have occurred in the datapoints configured to be flagged, the initiating of the application of the drift policy may be further configured to comprise, e.g. by means of a sending unit 908 within the node 111 configured to, sending the indication to the another node 112 configured to operate in the communications system 100 to indicate the detected drift.

The embodiments herein may be implemented through one or more processors, such as a processor 909 in the node 111 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the node 111. One such carrier may be in the form of a CD ROM disc. It is however feasible with other data carriers such as a memory stick. The computer program code may furthermore be provided as pure program code on a server and downloaded to the node 111.

The node 111 may further comprise a memory 910 comprising one or more memory units. The memory 910 is arranged to be used to store obtained information, store data, configurations, schedulings, and applications etc. to perform the methods herein when being executed in the node 111.

In some embodiments, the node 111 may receive information from, e.g., the another node 112, and/or another node through a receiving port 911. In some examples, the receiving port 911 may be, for example, connected to one or more antennas in the node 111. In other embodiments, the node 111 may receive information from another structure in the communications system 100 through the receiving port 911. Since the receiving port 911 may be in communication with the processor 909, the receiving port 911 may then send the received information to the processor 909. The receiving port 911 may also be configured to receive other information.

The processor 909 in the node 111 may be further configured to transmit or send information to e.g., the another node 112, another node, and/or another structure in the communications system 100, through a sending port 912, which may be in communication with the processor 909, and the memory 910.

Those skilled in the art will also appreciate that any of the units 901-908 described above may refer to a combination of analog and digital circuits, and/or one or more processors configured with software and/or firmware, e.g., stored in memory, that, when executed by the one or more processors such as the processor 909, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 901-908 described above may be the processor 909 of the node 111, or an application running on such processor.

Thus, the methods according to the embodiments described herein for the node 111 may be respectively implemented by means of a computer program 913 product, comprising instructions, i.e., software code portions, which, when executed on at least one processor 909, cause the at least one processor 909 to carry out the actions described herein, as performed by the node 111. The computer program 913 product may be stored on a computer-readable storage medium 914. The computer-readable storage medium 914, having stored thereon the computer program 913, may comprise instructions which, when executed on at least one processor 909, cause the at least one processor 909 to carry out the actions described herein, as performed by the node 111. In some embodiments, the computer-readable storage medium 914 may be a non-transitory computer-readable storage medium, such as a CD ROM disc, a memory stick, or stored in the cloud space. In other embodiments, the computer program 913 product may be stored on a carrier containing the computer program, wherein the carrier is one of an electronic signal, optical signal, radio signal, or the computer-readable storage medium 914, as described above.

The node 111 may comprise an interface unit to facilitate communications between the node 111 and other nodes or devices, e.g., the another node 112, another node, and/or another structure in the communications system 100. In some particular examples, the interface may, for example, include a transceiver configured to transmit and receive radio signals over an air interface in accordance with a suitable standard.

In other embodiments, the node 111 may comprise the following arrangement depicted in FIG. 9b. The node 111 may comprise a processing circuitry 909, e.g., one or more processors such as the processor 909, in the node 111 and the memory 910. The node 111 may also comprise a radio circuitry 915, which may comprise e.g., the receiving port 911 and the sending port 912. The processing circuitry 909 may be configured to, or operable to, perform the method actions according to FIG. 3, and/or FIGS. 4-5, in a similar manner as that described in relation to FIG. 9a. The radio circuitry 915 may be configured to set up and maintain at least a wireless connection with the another node 112, another node, and/or another structure in the communications system 100.

Hence, embodiments herein also relate to the node 111 operative for handling drift in data, the node 111 being operative to operate in the communications system 100. The node 111 may comprise the processing circuitry 909 and the memory 910, said memory 910 containing instructions executable by said processing circuitry 909, whereby the node 111 is further operative to perform the actions described herein in relation to the node 111, e.g., in FIG. 3, and/or FIGS. 4-5.

When using the word “comprise” or “comprising”, it shall be interpreted as non-limiting, i.e. meaning “consist at least of”.

The embodiments herein are not limited to the above-described preferred embodiments.

Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa.

Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

### REFERENCES

1. Lu, Jie, et al. “Learning under concept drift: A review.” IEEE Transactions on Knowledge and Data Engineering 31.12 (2018): 2346-2363.
2. Page, Ewan S. “Continuous inspection schemes.” Biometrika 41.1/2 (1954): 100-115.
3. Frias-Blanco, Isvani, et al. “Online and non-parametric drift detection methods based on Hoeffding's bounds.” IEEE Transactions on Knowledge and Data Engineering 27.3 (2014): 810-823.
4. Zhao, Di, and Yun Sing Koh. “Feature Drift Detection in Evolving Data Streams.” International Conference on Database and Expert Systems Applications. Springer, Cham, 2020.
5. Demšar, Jaka, and Zoran Bosnić. “Detecting concept drift in data streams using model explanation.” Expert Systems with Applications 92 (2018): 546-559.
6. Ribeiro, Marco Tulio, Sameer Singh, and Carlos Guestrin. ““Why should i trust you?” Explaining the predictions of any classifier.” Proceedings of the 22nd ACM SIGKDD international conference on knowledge discovery and data mining. 2016.
7. Li, Junbing, et al. “Deep-LIFT: Deep Label-Specific Feature Learning for Image Annotation.” IEEE Transactions on Cybernetics (2021).

1. A computer-implemented method, performed by a node, the method being for handling drift in data, the node operating in a communications system, the method comprising:
obtaining a dataset comprising a plurality of datapoints corresponding to a plurality of values of one or more dependent variables for a plurality of first features over a time period;
determining, using machine learning and explainability, in the absence of determining whether or not the plurality of datapoints has a drift, whether or not there has been a change in respective one or more characteristics of a subset of the plurality of first features in the plurality of datapoints having a largest contribution to a variability of the datapoints in the plurality of datapoints based on a threshold from a first time period to a second time period; and
initiating application of a drift policy on the plurality of datapoints based on a result of the determination of whether or not there has been a change.

2. The method of claim 1, wherein the obtained dataset is a second dataset, the plurality of datapoints is a second plurality of datapoints, the plurality of values is a second plurality of values, the subset is a second subset, the respective one or more characteristics are respective one or more second characteristics and the time period is the second time period, and wherein the method further comprises:
obtaining a first dataset comprising a first plurality of datapoints corresponding to a first plurality of values of the one or more dependent variables for the plurality of first features over a first time period; and
determining, using machine learning and explainability: i) a first subset of the plurality of first features having a largest contribution to a variability of the datapoints in the first set of datapoints based on a threshold, and ii) respective one or more first characteristics of the first subset of the plurality of first features, and wherein the determining of whether or not there has been a change is based on comparing the determined first subset and the respective one or more first characteristics with the second subset and the respective one or more second characteristics.

3. The method according to claim 1, further comprising:
obtaining a predictive model of the one or more dependent variables, based on the obtained first dataset and the plurality of first features, and wherein the determining of the first subset and the respective one or more first characteristics, and the determining of the second subset and the respective one or more second characteristics are further based on the obtained predictive model.

4. The method according to claim 1, wherein the initiating of the application of the drift policy comprises:
flagging any datapoints wherein the node has determined there has been change, and
determining whether or not there is drift using only the flagged datapoints.

5. The method according to claim 3, wherein drift is determined to have occurred in the flagged datapoints and wherein the initiating of the application of the drift policy further comprises at least one of:
retraining the obtained predictive model based on the determined drift,
replacing the obtained predictive model by another predictive model based on the determined drift, and
reverting to an earlier version of the obtained predictive model based on the determined drift.

6. The method according to claim 3, wherein the obtaining of the dataset comprising the plurality of datapoints is performed after an actuation executed based on the obtained predictive model.

7. The method according to claim 1, wherein drift is determined to have occurred in the flagged datapoints and wherein the initiating of the application of the drift policy further comprises:
sending an indication to another node operating in the communications system to indicate the detected drift.

8. (canceled)

9. A computer-readable storage medium, having stored thereon a computer program, comprising instructions which, when executed on at least one processor, cause the at least one processor to carry out operations comprising:
obtain a dataset comprising a plurality of datapoints corresponding to a plurality of values of one or more dependent variables for a plurality of first features over a time period;
determine, using machine learning and explainability, in the absence of determining whether or not the plurality of datapoints has a drift, whether or not there has been a change in respective one or more characteristics of a subset of the plurality of first features in the plurality of datapoints having a largest contribution to a variability of the datapoints in the plurality of datapoints based on a threshold from a first time period to a second time period; and
initiate application of a drift policy on the plurality of datapoints based on a result of the determination of whether or not there has been a change.

10. A node, for handling drift in data, the node being configured to operate in a communications system, the node being further configured to:
obtain a dataset configured to comprise a plurality of datapoints configured to correspond to a plurality of values of one or more dependent variables for a plurality of first features over a time period;
determine, using machine learning and explainability, in the absence of determining whether or not the plurality of datapoints has a drift, whether or not there has been a change in respective one or more characteristics of a subset of the plurality of first features in the plurality of datapoints configured to have a largest contribution to a variability of the datapoints in the plurality of datapoints based on a threshold from a first time period to a second time period; and
initiate application of a drift policy on the plurality of datapoints based on a result of the determination of whether or not there has been a change.

11. The node of claim 10, wherein the dataset configured to be obtained is configured to be a second dataset, the plurality of datapoints is configured to be a second plurality of datapoints, the plurality of values is configured to be a second plurality of values, the subset is configured to be a second subset, the respective one or more characteristics are configured to be respective one or more second characteristics and the time period is configured to be the second time period, and wherein the node is further configured to:
obtain a first dataset configured to comprise a first plurality of datapoints configured to correspond to a first plurality of values of the one or more dependent variables for the plurality of first features over a first time period; and
determine, using machine learning and explainability: i) a first subset of the plurality of first features configured to have a largest contribution to a variability of the datapoints in the first set of datapoints based on a threshold, and ii) respective one or more first characteristics of the first subset of the plurality of first features, and wherein the determining of whether or not there has been a change is configured to be based on comparing the determined first subset and the respective one or more first characteristics with the second subset and the respective one or more second characteristics.

12. The node according to claim 10, being further configured to:
obtain a predictive model of the one or more dependent variables, based on the obtained first dataset and the plurality of first features, and wherein the determining of the first subset and the respective one or more first characteristics, and the determining of the second subset and the respective one or more second characteristics are further configured to be based on the predictive model configured to be obtained.

13. The node according to claim 10, wherein the initiating of the application of the drift policy is further configured to comprise:
flagging any datapoints wherein the node is configured to have determined there has been change, and
determining whether or not there is drift using only the flagged datapoints.

14. The node according to claim 12, wherein drift is determined to have occurred in the flagged datapoints and wherein the initiating of the application of the drift policy is further configured to comprise at least one of:
retraining the predictive model configured to be obtained based on the drift configured to be determined,
replacing the predictive model configured to be obtained by another predictive model based on the drift configured to be determined, and
reverting to an earlier version of the predictive model configured to be obtained based on the drift configured to be determined.

15. The node according to claim 12, wherein the obtaining of the dataset comprising the plurality of datapoints is configured to be performed after an actuation configured to be executed based on the predictive model configured to be obtained.

16. The node according to claim 10, wherein drift is configured to be determined to have occurred in the datapoints configured to be flagged and wherein the initiating of the application of the drift policy is further configured to comprise:
sending an indication to another node configured to operate in the communications system to indicate the detected drift.

17. The computer-readable storage medium according to claim 9, wherein the obtained dataset is a second dataset, the plurality of datapoints is a second plurality of datapoints, the plurality of values is a second plurality of values, the subset is a second subset, the respective one or more characteristics are respective one or more second characteristics and the time period is the second time period, and wherein the operations further comprise:
obtain a first dataset comprising a first plurality of datapoints corresponding to a first plurality of values of the one or more dependent variables for the plurality of first features over a first time period; and
determine, using machine learning and explainability: i) a first subset of the plurality of first features having a largest contribution to a variability of the datapoints in the first set of datapoints based on a threshold, and ii) respective one or more first characteristics of the first subset of the plurality of first features, and wherein the determine of whether or not there has been a change is based on comparing the determined first subset and the respective one or more first characteristics with the second subset and the respective one or more second characteristics.

18. The computer-readable storage medium according to claim 9, wherein the operations further comprise:
obtain a predictive model of the one or more dependent variables, based on the obtained first dataset and the plurality of first features, and wherein the determine of the first subset and the respective one or more first characteristics, and the determine of the second subset and the respective one or more second characteristics are further based on the obtained predictive model.

19. The computer-readable storage medium according to claim 9, wherein the initiate of the application of the drift policy comprises:
flag any datapoints wherein the node has determined there has been change, and determine whether or not there is drift using only the flagged datapoints.

20. The computer-readable storage medium according to claim 18, wherein drift is determined to have occurred in the flagged datapoints and wherein the initiate of the application of the drift policy further comprises at least one of:
retrain the obtained predictive model based on the determined drift,
replace the obtained predictive model by another predictive model based on the determined drift, and
revert to an earlier version of the obtained predictive model based on the determined drift.

21. The computer-readable storage medium according to claim 18, wherein the obtain of the dataset comprising the plurality of datapoints is performed after an actuation executed based on the obtained predictive model.
